(19) United States
(12) Patent Application Publication
(10) Pub. No.: US 2009/0277514 A1
(43) Pub. Date: Nov. 12, 2009

(54) SYSTEM AND METHOD TO CONTROL CATALYST MIGRATION

(75) Inventor: Robert L. Gregory, Houston, TX (US)

Correspondence Address: STRASBURGER & PRICE, LLP;ATTN: IP SECTION, 1401 MCKINNEY, SUITE 2200, HOUSTON, TX, 77010, US

(73) Assignee: D-COK, LLC, Houston, TX (US)

(21) Appl. No.: 12/151,871

(22) Filed: May 9, 2008

(51) Int. Cl. F16K 17/00; B01J 19/00

(52) U.S. Cl. 137/455; 422/187; 422/68.1; 422/62

(57) ABSTRACT

In a fluid catalytic cracking process, catalyst migration through the vapor line from a reactor to a distillation column is controlled. Catalyst migration is controlled by detection, isolation, and removal of catalyst from the vapor line before entering the distillation column. Upon detection of a predetermined amount of catalyst in the vapor line, a signal is generated to close the valves in the vapor line, the catalyst feedstock line, and the regenerator/reactor line substantially simultaneously. Further, the distillation column can be isolated from the reactor for blind installation.

### CROSS-REFERENCE TO RELATED APPLICATIONS

N/A

### STATEMENT REGARDING FEDERALLY SPONSORED RESEARCH OR DEVELOPMENT

N/A

### REFERENCE TO MICROFICHE APPENDIX

N/A

### BACKGROUND OF THE INVENTION

1. Field of the Invention

The present invention relates to a system and method for a fluid catalytic cracking unit. In particular, the present invention relates to a system and method to control catalyst migration to the fractionator in a fluid catalytic cracking unit.

2. Description of the Related Art

Fluid catalytic cracking is a catalytic process in which heavy hydrocarbons are broken down into lighter components, such as gasoline and diesel. Pre-heated liquid hydrocarbon is fed into the base of a reactor or riser via feed nozzles. The hydrocarbon feed contacts hot fluidized catalyst, which vaporizes the hydrocarbon feed and catalyzes the cracking reactions that break down the high molecular weight oil. The catalyst-hydrocarbon vapor mixture flows upward through the reactor, and the catalyst and reaction product vapor is then separated via cyclones. The catalyst-free hydrocarbon vapor exits the top of the reactor and is routed through a vapor line to a main fractionator or distillation column for separation through condensation into slurry, diesel, gasoline and other light hydrocarbons. The spent catalyst exits the reactor and is routed to a regenerator, which burns the carbonaceous material or coke that becomes deposited on the catalyst as a result of the chemical reaction in the reactor. The regenerated catalyst is thereafter re-circulated back to the base of the reactor for mixing with the hydrocarbon feed, as discussed above, for continuation of the process. The combustion gases from burning the coke in the regenerator typically pass through cyclones to remove entrained catalyst, and are then routed out of the regenerator through a power recovery system.

During an operational upset of the fluid catalytic cracking process, caused by pressure surges or mechanical failures, a significant amount of catalyst in particulate form may migrate from the reactor to the distillation column. Once significant amounts of catalyst enter the main fractionator or distillation column, it may circulate within the column, including the slurry and HCO circuits. At times, the carryover of catalyst particulates may completely plug the bottom system(s) of the distillation column. A complete fluid catalytic cracking unit shutdown is often required to free the system of the solid catalyst. The downtime associated with cleaning the distillation column, and its associated circuits and packing, can take up to two weeks.

U.S. Pat. No. 4,392,345 proposes an optical sensor to detect catalyst particulates in the combustion gas line leading from a catalyst regenerator to a power recovery expander used in a power recovery system. The sensor signals a microprocessor, which closes a butterfly valve in the combustion gas line to protect the power recovery expander from a catalyst dump. U.S. Pat. No. 4,392,345 is incorporated herein by reference for all purposes its entirety.

It would be desirable to have a system and method for detection of catalyst migration between a reactor and a distillation column during the fluid catalytic cracking process to control catalyst migration during an operational upset. It would also be desirable to have a system and method to isolate and remove the catalyst before contamination of the distillation column.

### BRIEF SUMMARY OF THE INVENTION

A system and method is disclosed for detecting and isolating catalyst particulates moving through the vapor line from the reactor to the distillation column during the fluid catalytic cracking process. A sensing device in the vapor line determines the density of catalyst particulates in the flow, and generates a signal to a microprocessor to close a butterfly valve in the vapor line. The microprocessor also substantially simultaneously closes a feed valve in the hydrocarbon line transporting liquid hydrocarbon feedstock to the reactor and a regen slide valve in the line that transports fluidized regenerated catalyst to the reactor. A nozzle in the vapor line allows for removal of catalyst. An alternative embodiment allows the feedstock in the feedstock line to by-pass the reactor and continue to flow in another line in response to a signal from the sensing device. The system and method also allow for isolation of the distillation column from the reactor using the valve of the present invention in the reactor vapor line.

### BRIEF DESCRIPTION OF THE DRAWINGS

A better understanding of the present invention can be obtained with the following detailed descriptions of the various disclosed embodiments in the drawings, which are given by way of illustration only, and thus are not limiting the present invention:

FIG. 1 is a prior art schematic elevational diagram of a reactor with a vapor line exiting at its top and a hydrocarbon feedstock line having a valve entering at its base, and a partial cut away section elevational view of a regenerator with a catalyst line having a valve leading from the regenerator to the base of the reactor, a return line having a valve leading from the reactor to the regenerator, a combustion gas line at the top of the regenerator, and a fuel gas line at the base of the regenerator.

FIG. 2 is a schematic elevational diagram of a reactor with a vapor line connecting the reactor to the main fractionator, having a sensing device, a butterfly valve, and a nozzle of the present invention in the vapor line, a hydrocarbon feedstock line having a feed valve entering at the base of the reactor, a partial cut away section elevational view of a regenerator with a catalyst line having a regen slide valve leading from the regenerator to the base of the reactor, a return line having a spent catalyst slide valve leading from the reactor to the regenerator, a combustion gas line exiting the top of the regenerator, and an air line and a fuel gas line entering at the base of the regenerator, wherein the sensing device and the first (butterfly), second (feed), and third (regen slide valve) valves are connected with a microprocessor.

FIG. 3 is a schematic elevational diagram of a reactor having a vapor line between the reactor top and the main fractionator, with a sensing device, a butterfly valve, and a nozzle of the present invention in the line, a hydrocarbon feedstock line having a feed valve entering at the base of the reactor, a diverter line having a valve wherein the sensing device and the vapor, feedstock and diverter line valves are connected with a microprocessor.

FIG. 4 is an enlarged schematic diagram of a sensing device with a laser and photo transducer connected with a microprocessor.

### DETAILED DESCRIPTION OF THE INVENTION

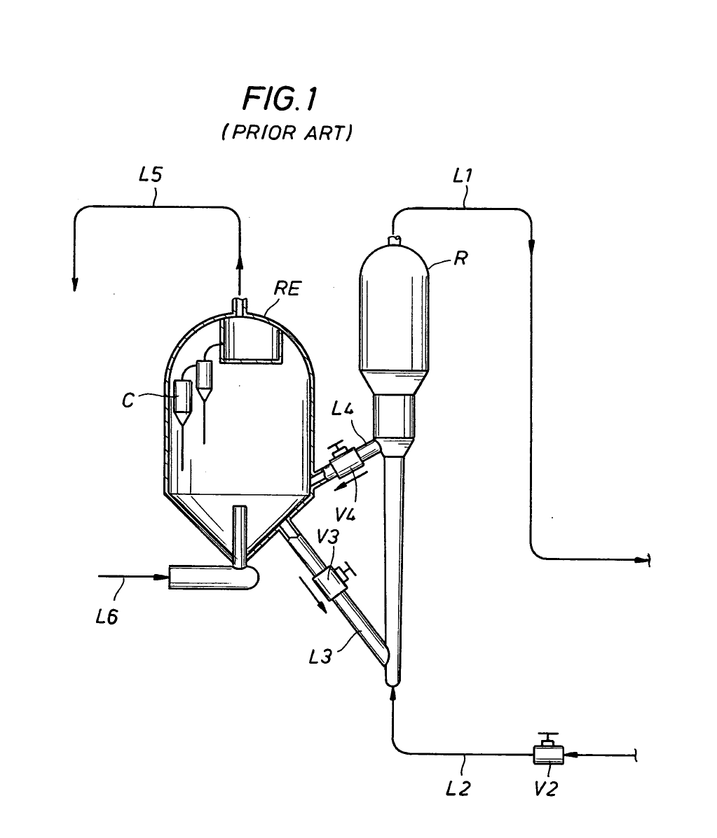

Turning to FIG. 1, a portion of an exemplary prior art fluid catalytic cracking unit with reactor R and regenerator RE is shown. First or vapor line L1 extends from the top of reactor R, and second or hydrocarbon feedstock line L2 with valve V2 enters the base of the reactor R. Third or catalyst line L3 with valve V3 extends between the regenerator RE and the base reactor R. Fourth or return line L4 with valve V4 also extends between reactor R and regenerator RE. Fifth or combustion gas line L5 extends from the top of regenerator RE, and fuel gas line L6 enters at the base of regenerator RE. Cyclones C, as discussed above, are in regenerator RE.

Pre-heated liquid hydrocarbon feedstock flows through line L2 to the base of reactor R. Hot fluidized catalyst flows through line L3. It is intended that catalyst-free hydrocarbon vapor exits through vapor line L1. However, as previously discussed, catalyst sometimes leaves the reactor R through vapor line L1. Spent catalyst returns from the reactor R to the catalyst regenerator RE through line L4. Combustion gas exits the regenerator RE through line L5. Fuel gas enters the regenerator RE through line L6 at start up only. Cyclones C in regenerator RE generally remove the larger particles of catalyst from the combustion gas for re-circulation of the catalyst back into catalyst line L3. The direction of flow through lines (L1, L2, L3, L4, L5, L6) is shown in FIG. 1 with arrows.

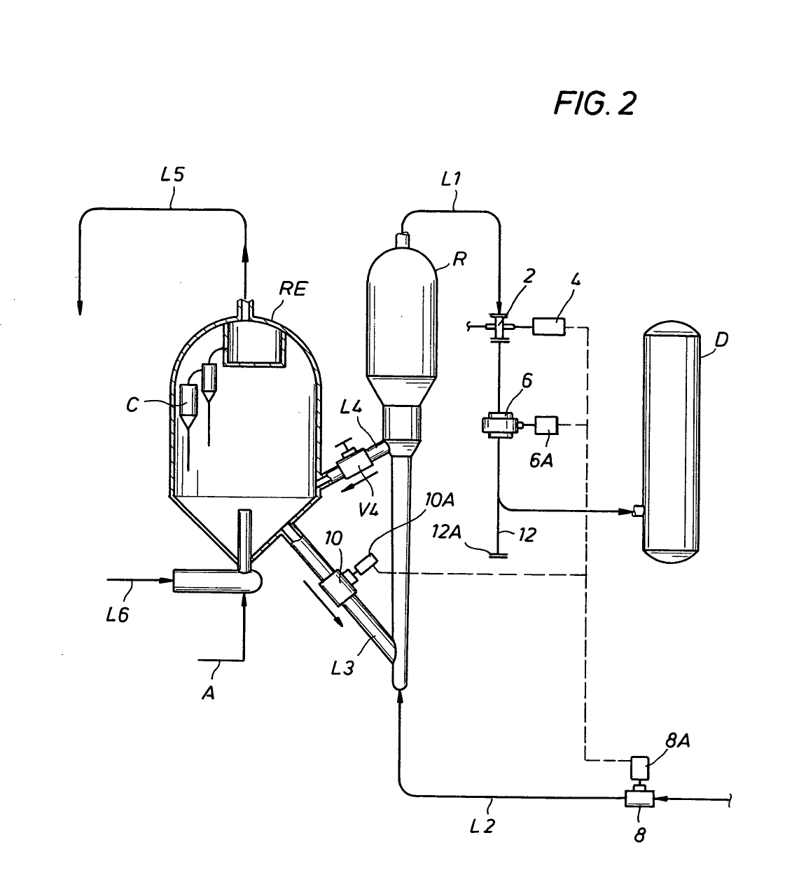

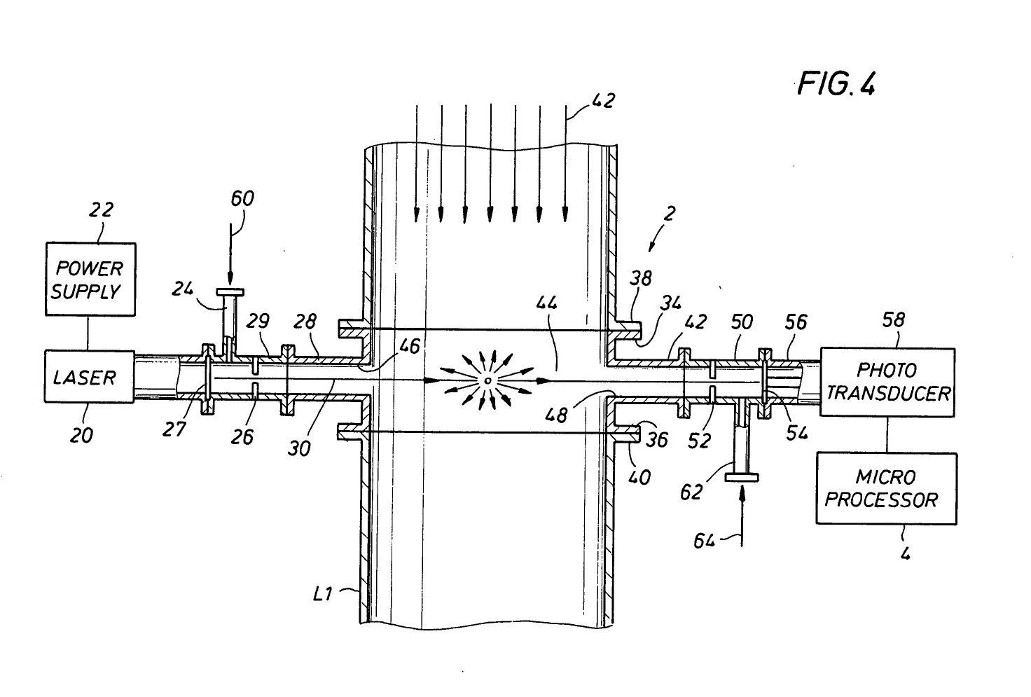

FIG. 2 shows one embodiment of the present invention. After exiting reactor R, vapor line L1 passes through sensing device 2 and valve 6. Valve 6 is preferably a butterfly valve, although other valves are contemplated. Sensing device 2 and actuator 6A for valve 6 may be electrically connected with a microprocessor 4. Sensing device 2 may preferably detect a density of particulates in the flow in line L1. One such sensing device 2, that will be described below in detail, is shown in FIG. 4. Returning to FIG. 2, nozzle 12A is preferably in communication with line L1 before line L1 enters distillation column D. It is also contemplated that a nozzle 12A may be located in a stub-out or dump line 12 that diverts from first line L1 as line L1 begins a change in direction. Other locations are contemplated as well. Actuators 8A and 10A for valve 8 in line L2 and valve 10 in line L3, respectively, may also be connected with microprocessor 4. Valve 10 preferably is a slide valve, although other valves are contemplated. In response to a signal from sensing device 2, microprocessor 4 is programmed to signal actuators 6A, 8A, 10A to close valves (6, 8, 10) respectively. In the preferred embodiment, all valves (6, 8, 10) are closed substantially simultaneously. However, it is also contemplated that any combination of valves (6, 8, 10) may be closed and at different time sequences. For example, valves (6, 8) may be closed and valve 10 left open, so that the system may be in hot stand-by mode.

Catalyst may be removed through nozzle 12A after valve 6 is closed. Shut down of feed and catalyst to the reactor R addresses any relief valve requirements, since pressure protection for most reactors is located on the distillation column D or at the inlet of the distillation column on the vapor line L1. As can now be understood, valve 6 can be operated independently of sensing device 2 and/or manually to close first line L1 to isolate distillation column D from reactor R, such as for blind installation in the reactor vapor line. It should also be understood that any combination of valves (6, 8, 10) may also be opened by microprocessor 4 in response to a signal from sensing device 2 or by operation of a control panel by an operator operably connected to the microprocessor 4. The operation of regenerator RE is the same as described for FIG. 1. However, in FIG. 2, an input line A for combustion air is shown for regenerator RE. The direction of flow through lines (L1, L2, L3, L4, L5, L6, A) is shown with arrows.

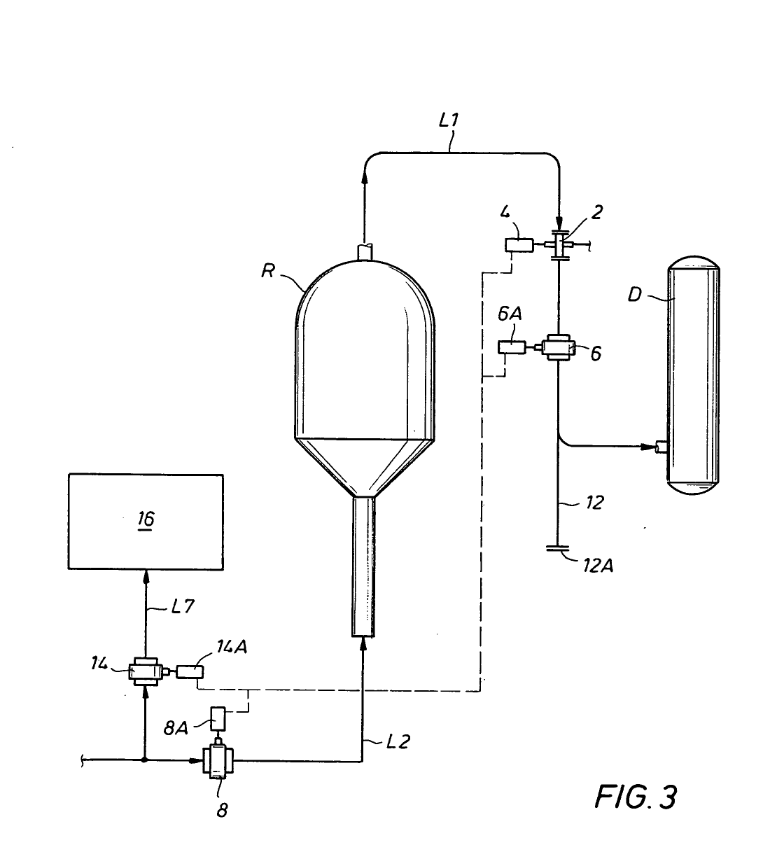

Turning to FIG. 3, another embodiment of the present invention is shown. Microprocessor 4 and line L1 with sensing device 2, valve 6, actuator 6A, and nozzle 12A are identical to FIG. 2. However, unlike FIG. 2, diverter line L7 is in communication with and diverts from line L2. Actuators 8A and 14A for valve 8 in line L2 and valve 14 in line L7 may be connected with microprocessor 4. In response to a signal from sensing device 2, valves (6, 8, 14) may be closed or opened. In the preferred mode, when particulate or catalyst is detected in line L1 above a predetermined value, then valves (6, 8) may be closed and valve 14 may be opened. As can now be understood, when second valve 8 is closed and valve 14 opened, feedstock may exit line L2, enter diverter line L7 and be diverted away from reactor R while continuing to move in stand-by mode. Line L7 may be in fluid communication with a feed surge drum or other container 16.

It is also contemplated that valves (8, 14) may be replaced with a single valve that has an input for second line L2 or line L7. It is contemplated that a flip-flop valve may be used to direct flow to the desired line. However, other valves are contemplated. In response to a signal from the microprocessor 4, such valve may open one output and close the other output. Although regenerator RE, line L3, valve 10, actuator 10A, line L4, valve V3, and lines (L5, L6) are not shown in FIG. 3 for clarity, it is contemplated that they may be incorporated into the embodiment disclosed in FIG. 3 as they are shown in FIG. 2. As can now be understood, when microprocessor 4 closes valve 6 and valve 8, and opens valve 14, it may also close valve 10. It is also contemplated that catalyst may continue to circulate through lines (L3, L4) between reactor R and regenerator RE, and valve 10 may remain open.

FIG. 4 shows sensing device, generally indicated as 2, as previously depicted in FIGS. 2 & 3. Optical sensing device 2 has flanges (34, 36) for removable attachment with flanges (38, 40) of line L1. Laser light source 20 is electrically connected to power supply 22. Laser source 20 transmits a beam of light 30 perpendicular to the flow path 42. Sensor housing section 44 includes aligned and opposed elongated cylindrical members (28, 42). Cylindrical members (28, 42) contain respective orifices or apertures (46, 48) in communication with the interior surface of housing section 44. Laser source 20 transmits a beam of light 30 that passes through laser window 27, purge structure 29 which includes pressure maintaining orifice 26, member 28, aperture 46, across flow path 42, through aperture 48, member 42, purge structure 50 which includes pressure maintaining orifice 52 and lens 54 before reaching sensor element 56.

Sensor element 56 is preferably a fiber optic device that transmits the beam of light 30 received from laser source 20 to photo transducer 58 which in turn sends an electrical signal to microprocessor 4. Valve 24 controls the passage of a pressurized fluid 60, such as air, into purge structure 29 for pressurizing the chamber defined by member 28 to prevent particulate matter from entering into the chamber of member 28 via aperture 46. Similarly, valve 62 controls the passage of a pressurized fluid 64, such as air, into purge structure 50 for pressurizing the chamber defined by member 42 to prevent particulate matter from entering into the chamber of member 42 via aperture 48.

Although FIG. 4 shows the preferred embodiment, other sensing devices are contemplated as well, such as those for detection of particles using radiation, sonar, radio frequency, or optics. In one alternative embodiment, the sensing device may be a nuclear sensing device that may generate a beam from a radioactive material contained in a transmitter that may be radiated across line L1, and the change in intensity detected at the opposite side of line L1 by a tubular receiver.

### Method of Use

As best shown in FIG. 2, pre-heated liquid hydrocarbon feed moves through line L2 to the base of reactor R. Hot fluidized catalyst moves through line L3 to the base of reactor R. The catalyst-hydrocarbon mixture flows upward, until the mixture is separated via cyclones (not shown) within the reactor R. Spent catalyst moves through line L4 back to regenerator RE. A desirable catalyst-free hydrocarbon vapor exits reactor R through line L1. However, as previously discussed, undesirable catalyst particles may also continue to move through line L1, such as for example if there is a pressure surge or mechanical failure. Sensing device 2, detects catalyst particles in the flow and transmit to the microprocessor 4. The microprocessor 4 is calibrated in advance with a predetermined value to identify an event, which is typically an excessive carryover of catalyst.

As the beam of light 30 strikes the particulate matter, the light is dispersed according to the density or concentration of the particulate matter within flow path 42. A signal is generated by photo transducer 58 and transmitted to microprocessor 4. Microprocessor 4 signals actuators 6A, 8A and 10A to close valve 6, valve 8 and valve 10, respectively, substantially simultaneously. Alternatively, the microprocessor 4 could be programmed to close any combination of the valves (6, 8, 10) in any desired time sequence. Once the unit is shut down and stabilized, catalyst accumulation in line L1 may be removed or dumped through nozzle 12A. It is contemplated that valve V4 in line L4 could be actuated by a signal from microprocessor 4 or operated manually. The wet gas compressor will react based on controls in place to protect the machine, and will continue to operate with full spillback capability or shutdown. It should now be understood that distillation column D may be isolated from reactor R at any time by closing first valve 6, which allows for operations on distillation column D, including blind installation.

The method of use of the alternative embodiment shown in FIG. 3 is similar to that described above for FIG. 2, except that when microprocessor 4 closes valve 6 and valve 8, it may also open valve 14. Feed may continue to circulate and be diverted away from reactor R through line L7 to a feed surge drum or other storage container 16. Diverting feed and closing valve 10 addresses relief requirements for the reactor R. As described previously, it is contemplated that regenerator RE, line L3, valve 10, line L4, valve V3, and lines (L5, L6) may be incorporated into the alternative system in FIG. 3 as they are disclosed in FIG. 2. When microprocessor 4 closes valve 6 and valve 8 and opens valve 14, it may also close valve 10. Alternatively, catalyst may continue to circulate through lines (L3, L4) between reactor R and regenerator RE, and valve 10 may remain open. Again, as can now be understood, in any embodiment the valves (6, 8, 10, 14) may be opened or closed individually, manually or in combination. Further, valves (6, 8, 10, 14) may be operated substantially simultaneously, if desired.

The foregoing disclosure and description of the invention are illustrative and explanatory thereof, and various changes in the details of the illustrated apparatus and system, and the construction and the method of operation may be made without departing from the spirit of the invention.

I claim:

1. A system for isolating a distillation column, comprising:
a reactor;
a first fluid line for communicating a reactor fluid from said reactor, and
a first valve for controlling the flow of said reactor fluid in said first fluid line to the distillation column.

2. The system of claim 1, further comprising a sensing device for determining a density of a particulate in said first fluid line and for generating a signal indicative of said sensed density.

3. The system of claim 2, wherein said first valve is actuated in response to said signal.

4. The system of claim 3, further comprising:
a second fluid line for communicating a hydrocarbon fluid to said reactor; and
a second valve for controlling the flow of said hydrocarbon fluid in said second fluid line.

5. The system of claim 4, wherein said second valve is actuated in response to said signal.

6. The system of claim 5, further comprising:
a third fluid line for communicating a catalyst to said reactor; and
a third valve for controlling the flow of said catalyst in said third fluid line.

7. The system of claim 6, wherein said third valve is actuated in response to said signal.

8. The system of claim 7, wherein said first, second, and third valves are actuated substantially simultaneously in response to said signal.

9. The system of claim 2, wherein said sensing device is located closer to said reactor than said first valve as measured along said first fluid line.

10. The system of claim 1, further comprising a dump line, said first fluid line communicating with said dump line and a dump line nozzle.

11. The system of claim 7, further comprising a regenerator in fluid communication with said third fluid line.

12. The system of claim 2, wherein said sensing device comprises a laser and a photo transducer.

13. The system of claim 1, wherein said first valve is a butterfly valve.

14. The system of claim 6, wherein said third valve is a slide valve.

15. The system of claim 2, wherein said sensing device further detects a predetermined amount of catalyst.

16. The system of claim 7, further comprising a fourth fluid line for diverting catalyst fluid from said second fluid line to bypass to said reactor.

17. The system of claim 16 further comprising a fourth valve for diverting fluid from said second fluid line to said fourth fluid line.

18. The system of claim 17, wherein said second valve and said fourth valve are arranged as a flip-flop valve.

19. The system of claim 17, wherein said fourth valve is in an open position when said second valve is closed for controlling the flow of fluid in said second fluid line.

20. The system of claim 19, wherein said fourth valve is actuated in response to said signal.

21. The system of claim 20, wherein said first, second, third, and fourth valves operate substantially simultaneously in response to receiving said signal.

22. The system of claim 21, further comprising a container in fluid communication with said fourth fluid line.

23. A system for isolating catalyst, comprising:
a reactor;
a first fluid line for communicating a reactor fluid from said reactor;
a sensing device for determining a density of a particulate in said first fluid line and for generating a signal indicative of said sensed density; and
a first valve for controlling the flow of said reactor fluid in said first fluid line.

24. The system of claim 23, wherein said first valve is actuated in response to receiving said signal.

25. The system of claim 24, further comprising:
a second fluid line for communicating a hydrocarbon fluid to said reactor; and
a second valve for controlling the flow of said hydrocarbon fluid in said second fluid line.

26. The system of claim 25, wherein said second valve is actuated in response to receiving said signal.

27. The system of claim 26, further comprising:
a third fluid line for communicating a catalyst to said reactor; and
a third valve for controlling the flow of said catalyst in said third fluid line.

28. The system of claim 27, wherein said third valve is actuated in response to receiving said signal.

29. A method for isolating a distillation column from a reactor, comprising the step of:
closing a first valve in a first fluid line from the reactor to the distillation column.

30. The method of claim 29, further comprising the steps of:
moving a reactor fluid through said first fluid line from the reactor to the distillation column; and
sensing a density of a particulate in said first fluid line; and
generating a signal indicative of said sensed density.

31. The method of claim 30, wherein said first valve closes in response to receiving said signal and wherein the steps of sensing and generating occur before the step of closing said first valve in said first fluid line.

32. The method of claim 31, further comprising the steps of:
moving a hydrocarbon fluid through a second fluid line to said reactor; and
closing a second valve in said second fluid line.

33. The method of claim 32, wherein said second valve closes in response to receiving said signal.

34. The method of claim 33, further comprising the steps of:
moving catalyst through a third fluid line to said reactor; and
closing a third valve in said third fluid line.

35. The method of claim 34, wherein said third valve closes in response to receiving said signal.

36. The method of claim 35, wherein said first, second, and third valves are closed substantially simultaneously in response to receiving said signal.

37. The method of claim 30, further comprising the step of:
moving catalyst from said first fluid line through a nozzle.

38. The method of claim of claim 35, further comprising the step of:
diverting fluid from said second fluid line to a fourth fluid line to bypass said reactor.

39. The method of claim of claim 38, wherein closing said second valve diverts fluid to said fourth fluid line.

40. The method of claim 38, further comprising the step of opening a fourth valve in said fourth fluid line.

41. The method of claim 40, wherein said fourth valve opens in response to receiving said signal.

42. The method of claim 41, wherein said first, second, third, and fourth valves are actuated substantially simultaneously in response to receiving said signal.
